(19) United States
(12) Patent Application Publication
(10) Pub. No.: US 2017/0328769 A1
(43) Pub. Date: Nov. 16, 2017

(54) Measurement of Fluid Properties Using Integrated Computational Elements

(71) Applicant: Halliburton Energy Services, Inc., Houston, TX (US)

(72) Inventors: Michael T. Pelletier, Houston, TX (US); William J. Soltmann, The Woodlands, TX (US); David L. Perkins, The Woodlands, TX (US); Raj Pai, Houston, TX (US); James E. Masino, Houston, TX (US)

(73) Assignee: Halliburton Energy Services, Inc., Houston, TX (US)

(21) Appl. No.: 15/523,819

(22) PCT Filed: Dec. 31, 2014
(86) PCT No.: PCT/US2014/073076

§ 371 Date: May 2, 2017

(51) Int. Cl. G01J 3/02; G01V 3/30; G06F 9/30; E21B 49/08; G01J 3/12

(52) U.S. Cl. CPC G01J 3/0205; G06F 9/30007; E21B 49/081; G01V 3/30; G01J 2003/1226

(57) ABSTRACT

Systems, tools, and methods are disclosed that utilize at least one integrated computational element to measure a property of a substance in close proximity to the substance's source. More specifically, systems, tools, and methods are presented that allow the interaction of electromagnetic radiation and the optically-processing of interacted electromagnetic radiation in proximity to an emergence of a fluid from the fluid's source. The integrated computational elements optically-process the interacted electromagnetic radiation into a weighted optical spectrum. The weighted optical spectrum enables the determination of various chemical or physical characteristics of the fluid.

### TECHNICAL FIELD

The present disclosure relates generally to the measurement of characteristics of a substance using integrated computational elements, and more particularly, to systems and methods to measure characteristics of a substance in proximity to the substance's emergence from a source, such as a subterranean reservoir. The integrated computational elements are configured to enable the measurement of various chemical or physical characteristics of the substance.

### BACKGROUND

In producing fluids from an oil and gas well, it is often advantageous to learn as much about the fluids in the well as possible. In recent times, more and more information is being developed by downhole instruments and tools. Still, additional information and improvements are desired. Integrated computational elements assist in identifying fluids or fluid characteristics. The integrated computational elements detect interacted electromagnetic radiation from a sample.

### BRIEF DESCRIPTION OF THE DRAWINGS

Illustrative embodiments of the present disclosure are described in detail below with reference to the attached drawing figures, which are incorporated by reference herein and wherein:

FIG. 1 is a cross-sectional view of a portion of an illustrative embodiment of an integrated computational element for processing a sample electromagnetic radiation representing a chemical constituent of a production fluid from a wellbore or other source;

FIG. 2 is a schematic, elevation view of an illustrative embodiment of a measurement system, shown in context, for measuring a property of a production fluid from a wellbore in proximity to the production fluid's emergence from a subterranean reservoir;

FIG. 3 is a detail view of a portion of the measurement system of FIG. 2 that shows, in cross-section, an illustrative embodiment of an analytical tool deployed adjacent to a subterranean reservoir;

FIG. 4 is an illustrative embodiment of an apparatus for measuring, using optical reflection, a property of a fluid in proximity to the fluid's emergence from a source such as a subterranean reservoir;

FIG. 5 is a schematic plan view of an apparatus for measuring, using optical transmission, a property of a fluid in proximity to the fluid's emergence from a source;

FIG. 6A is a schematic plan view of a substrate having a plurality of illumination sources and an optical analyzer for use in a measurement system according to an illustrative embodiment;

FIG. 6B is an illustrated embodiment of a substrate having a plurality of optical analyzers and an illumination source for use in a measurement system according to an illustrative embodiment;

FIG. 7 is a schematic, elevation view of an illustrative embodiment of a measurement system, shown in context, for measuring a property of a production fluid from a wellbore in proximity to the production fluid's emergence from a subterranean reservoir; and

FIG. 8 is a schematic, elevation view of an illustrative embodiment of a measurement system, shown in context, for measuring a property of a production fluid from a wellbore in proximity to the production fluid's emergence from a subterranean reservoir.

The illustrated figures are only exemplary and are not intended to assert or imply any limitation with regard to the environment, architecture, design, or process in which different embodiments may be implemented.

### DETAILED DESCRIPTION OF ILLUSTRATIVE EMBODIMENTS

In the following detailed description of the illustrative embodiments, reference is made to the accompanying drawings that form a part hereof. These embodiments are described in sufficient detail to enable those skilled in the art to practice the disclosed tools, systems, and methods, and it is understood that other embodiments may be utilized and that logical structural, mechanical, electrical, and chemical changes may be made without departing from the scope of the disclosure. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

In the drawings and description that follow, like parts are typically marked throughout the specification and drawings with the same reference numerals or coordinated numerals. The drawing figures are not necessarily to scale. Certain features of the invention may be shown exaggerated in scale or in somewhat schematic form and some details of conventional elements may not be shown in the interest of clarity and conciseness.

Information about a substance can be derived through the optical interaction of electromagnetic radiation, e.g., light, with that substance. The interaction changes the electromagnetic radiation to form a sample electromagnetic radiation. For example, interacted light may change with respect to frequency (and corresponding wavelength), intensity, polarization, or direction (e.g., through scattering, reflection, or refraction). This sample electromagnetic radiation may be processed to determine chemical or physical characteristic of the substance (e.g., compositional, thermal, physical, mechanical, and optical among others). The characteristics of the substance can be determined based on changes in the electromagnetic radiation. As such, in certain applications, one or more characteristics of a substance, such as crude petroleum, gas, water, or other production fluids from a wellbore can be derived in situ, e.g., upon emergence out of an subterranean reservoir, as a result of the interaction between these substances and electromagnetic radiation. An integrated computational element (ICE) can be used for this purpose.

The optical computing devices described herein may be used in the oil and gas industry, such as for monitoring and detecting oil/gas-related substances (e.g., hydrocarbons, cements, drilling fluids, completion fluids, treatment fluids, etc.). It will be appreciated, however, that the optical computing devices described herein may equally be used in other technology fields including, but not limited to, the food industry, the paint industry, the mining industry, the agricultural industry, the medical and pharmaceutical industries, the automotive industry, the cosmetics industry, water treatment facilities, and any other field where it may be desired to monitor substances in real time.

As used herein, the term “substance,” or variations thereof, refers to at least a portion of matter or material of interest to be tested or otherwise evaluated with the help of the optical computing devices described herein. The substance may be any fluid capable of flowing, including particulate solids, liquids, gases (e.g., air, nitrogen, carbon dioxide, argon, helium, methane, ethane, butane, and other hydrocarbon gases, hydrogen sulfide, and combinations thereof), slurries, emulsions, powders (e.g., cements, concretes, etc.), drilling fluids (i.e., “muds”), glasses, mixtures, combinations thereof. The substance may include, but is not limited to, aqueous fluids (e.g., water, brines, etc.), non-aqueous fluids (e.g., organic compounds, hydrocarbons, oil, a refined component of oil, petrochemical products, and the like), acids, surfactants, biocides, bleaches, corrosion inhibitors, foamers and foaming agents, breakers, scavengers, stabilizers, clarifiers, detergents, treatment fluids, fracturing fluids, formation fluids, or any oilfield fluid, chemical, or substance commonly found in the oil and gas industry. The substance may also refer to solid materials such as, but not limited to, rock formations, concrete, solid wellbore surfaces, pipes or flow lines, and solid surfaces of any wellbore tool or projectile (e.g., balls, darts, plugs, etc.).

As used herein, the term “characteristic” refers to a chemical, mechanical, or physical property of the substance and may include a quantitative or qualitative value of one or more chemical constituents or compounds present therein or any physical property associated therewith. Such chemical constituents and compounds may be referred to herein as “analytes.” Illustrative characteristics of a sample that can be measured with the apparatus described herein can include, for example, chemical composition (e.g., identity and concentration in total or of individual components), phase presence (e.g., gas, oil, water, etc.), impurity content, pH, alkalinity, viscosity, density, ionic strength, total dissolved solids, salt content (e.g., salinity), porosity, opacity, bacteria content, total hardness, combinations thereof, state of matter (solid, liquid, gas, emulsion, mixtures, etc.), and the like.

As used herein, the term “electromagnetic radiation” refers to radio waves, microwave radiation, terahertz, infrared and near-infrared radiation, visible light, fluorescent light, ultraviolet light, X-ray radiation and gamma ray radiation.

As used herein, the phrase “optically interact” or variations thereof refers to the reflection, transmission, scattering, diffraction, or absorption of electromagnetic radiation either on, through, or from an optical processing element (e.g., an integrated computational element) or a substance being analyzed with the optical computing device. Accordingly, optically interacted light refers to electromagnetic radiation that has been reflected, transmitted, scattered, diffracted, or absorbed by, emitted, or re-radiated, for example, using an optical processing element, but may also apply to optical interaction with a substance.

Integrated computational elements enable the measurement characteristics of substances through the use of regression techniques. An integrated computational element may be formed with a substrate, e.g., an optically-transparent substrate, having multiple stacked dielectric layers or films (e.g., 2 to 50 or more layers). In such stacks, each layer or film has a different refractive index from adjacent neighbors. While layers or films are referenced herein, it should be understood that the integrated computational element is not an optical filter, but an optical processor. Sample electromagnetic radiation may be optically processed by the integrated computational element to isolate a spectrum specific to a chemical constituent. Specifically, the integrated computational element is operational via reflection, refraction, interference, or a combination thereof to weight the sample electromagnetic radiation on a per-wavelength basis. This weighting process produces an optical spectrum representative of the chemical constituent or some feature.

The accuracy of one or more determined properties may be improved by measuring a substance in close proximity to the substance's source. For example, a production fluid from a subterranean reservoir often contains hydrogen sulfide. If the production fluid is transported away from its source, the concentration of hydrogen sulfide may diminish due to uncontrolled diffusion into conveyance tubing. Thus, any compositionally-dependent properties determined remotely from the point of emergence may not accurately represent those of the source.

The embodiments described herein relate to systems, tools, and methods that utilize at least one integrated computational element to measure a property of a substance in close proximity to the substance's source. More specifically, systems, tools, and methods are presented that enable the interaction of electromagnetic radiation and the optical-processing of sample electromagnetic radiation in proximity to an emergence of a fluid from the fluid's source.

As referenced herein, the term “side” corresponds to an area or volume adjacent to a surface, a body, or a specific feature of a component. When used in conjunction with the term “side”, the term “proximate” (e.g., “proximate a side”) refers to the area or volume associated with the “side”, but may also include additional area or volume that is adjacent to the area or volume associated with the “side”.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to”. Unless otherwise indicated, as used throughout this document, “or” does not require mutual exclusivity.

The various characteristics mentioned above, as well as other features and characteristics described in more detail below, will be readily apparent to those skilled in the art with the aid of this disclosure upon reading the following detailed description of the embodiments, and by referring to the accompanying drawings.

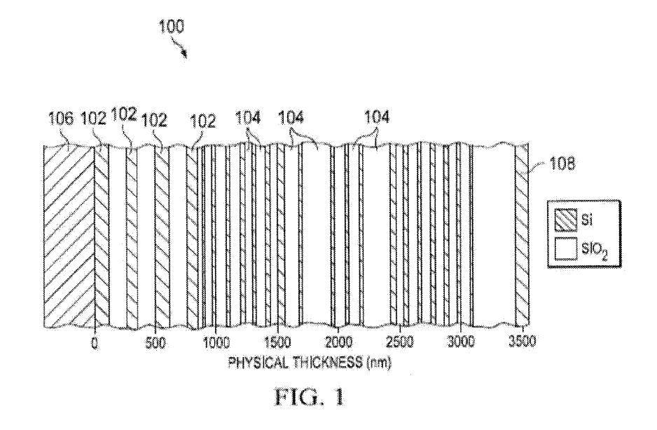

Now referring primarily to FIG. 1, a cross-sectional view of a portion of an illustrative embodiment of an integrated computational element 100 for processing a sample electromagnetic radiation is shown. The integrated computational element 100 may include alternating layers of high refractive index 102 and low refractive index 104 materials. Herein, the term refractive index means the complex indices of refraction (n, k). In the embodiment illustrated by FIG. 1, the layers of high refractive index 102 may be formed of silicon and those of low refractive index 104, silicon dioxide. This embodiment, however, is not intended as limiting. The layers 102 may be formed of other materials that have a high refractive index. Non-limiting examples of such materials include germanium, aluminum arsenide, gallium arsenide, indium phosphide, silicon carbide, and titanium dioxide. Additional semiconductor or dielectric materials are possible. Similarly, the layers 104 may be formed of other materials that have a low refractive index. Non-limiting examples of these materials include germanium dioxide, magnesium fluoride, and aluminum oxide. The number of layers, the materials used for each layer, and the different refractive indices in integrated computational element 100 are representative and should not be considered limiting. For example, without limitation, the integrated computational element 100 may be comprised of three or more materials with different refractive indices.

The integrated computational element 100 may be fabricated on a substrate 106, e.g., an optically-transparent substrate, to provide support for the layers 102, 104. The substrate 106 may be a single crystal, a polycrystalline ceramic, an amorphous glass, or a plastic material. In some embodiments, the substrate 106 may be formed of BK-7 optical glass. In other embodiments, the substrate 106 may be quartz, diamond, sapphire, silicon, germanium, magnesium fluoride, aluminum nitride, gallium nitride, zinc selenide, zinc sulfide, fused silica, polycarbonate, polymethylmethacrylate (PMMA), or polyvinylchloride (PVC). Other substrates are possible. In still other embodiments, the integrated computational element 100 includes an optional capping layer 108 that, during operation, may be exposed to the production fluid.

The layers 102 and 104, the substrate 106, and the capping layer 108 (if present) may function in combination as an integrated computational element. The integrated computational element optically processes a sample electromagnetic radiation according to a spectral weighting (i.e., a wavelength-dependent weighting). In operation, a sample electromagnetic radiation from a fluid may enter and interact with the integrated computational element 100. The layers 102, 104 may induce reflection, refraction, interference, or a combination thereof within the integrated computational element 100 to alter an intensity of the electromagnetic radiation on a per-wavelength basis. The electromagnetic radiation may exit the integrated computational element as a weighted optical spectrum whose individual wavelengths have been proportionately processed by the integrated computational element 100.

The spectral weighting may be controlled by the choice of substrate, thickness of the layers, complex index of refraction of the substrate and layers, and a number of individual layers 102, 104 of the integrated computational element 100. The substrate, thicknesses, the refractive index (i.e., material), and the number of layers may be selected according to a design of the integrated computational element 100 to characterize a chemical constituent or property of the fluid to be analyzed. For example, the integrated computational element 100 may be used downhole to allow production fluids downhole to be quickly analyzed. Similarly, the integrated computational element may also be deployed in conjunction with cellular tissue to analyze blood, saliva, perspiration, or other biological fluids upon their extraction or secretion. Other fluid types are possible and vary according with application.

During analysis of the fluid, electromagnetic radiation may be passed through the fluid and delivered to an integrated computational element incorporating the design to produce sample electromagnetic radiation. Interaction of the electromagnetic radiation with the fluid allows the electromagnetic radiation to acquire optical characteristics that represent attributes of the fluid. Subsequent optical processing of the sample electromagnetic radiation by the integrated computational element allows the determination of desired information about the chemical constituent (e.g., concentration) in the fluid.

It should be understood that the design shown in FIG. 1 does not necessarily correspond to any particular chemical constituent, but is provided for purposes of illustration only. Furthermore, the layers 102, 104 and their relative thicknesses are not necessarily drawn to scale, and therefore should not be considered limiting of the present disclosure. The number of layers 102, 104, their relative thicknesses, and their materials of construction, as shown in FIG. 1, may bear little correlation to any particular characteristic of a production fluid. It should also be noted that the physical thickness of the device and/or layers should not be considered limiting, and is for purposes of illustration only.

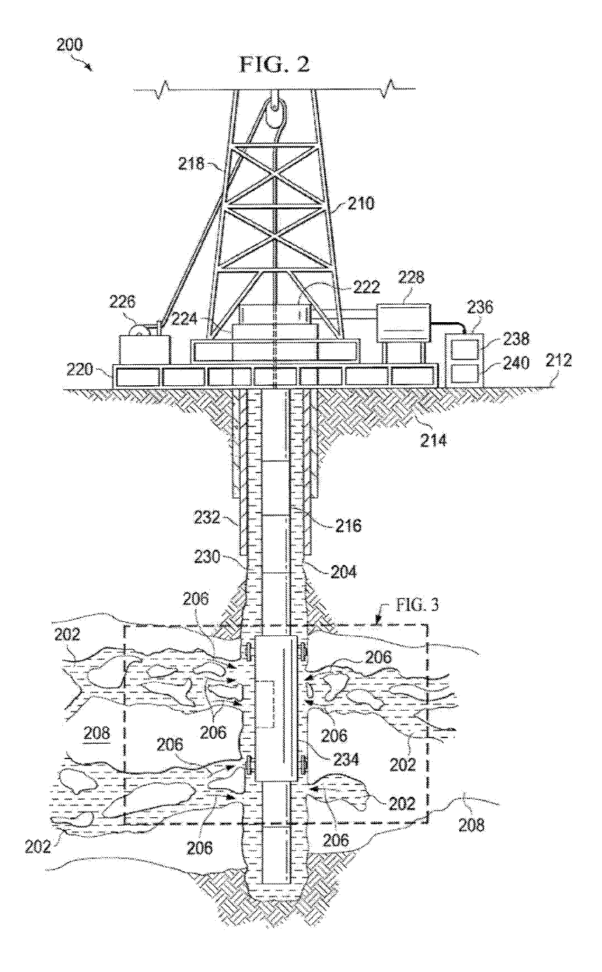

Referring now primarily to FIG. 2, an illustrative embodiment is presented for a measurement system 200 for measuring a property of a production fluid 202 from a wellbore 204 in proximity to an emergence 206 of the production fluid from a subterranean reservoir 208. The measurement system 200 includes a rig 210 atop a surface 212 of a well 214. Beneath the rig 210, the wellbore 204 is formed within the subterranean reservoir 208, which is expected to produce hydrocarbons. The wellbore 204 may be formed in the subterranean reservoir 208 using a drill string that includes a drill bit to remove material from the subterranean reservoir 208. The wellbore 204 of FIG. 2 is shown as being near-vertical, but may be formed at any suitable angle to reach a hydrocarbon-rich portion of the subterranean reservoir 208. In some embodiments, the wellbore 204 may follow a vertical, partially-vertical, angled, or even a partially-horizontal path through the subterranean reservoir 208.

A production tool string 216 is deployed from the rig 210, which may be a drilling rig, a completion rig, a workover rig, or another type of rig. The rig 210 includes a derrick 218 and a rig floor 220. The production tool string 216 extends downward through the rig floor 220, through a fluid diverter 222 and blowout preventer 224 that provide a fluidly sealed interface between the wellbore 204 and external environment, and into the wellbore 204 and subterranean reservoir 208. The rig 210 may also include a motorized winch 226 and other equipment for extending the production tool string 216 into the wellbore 204, retrieving the production tool string 216 from the wellbore 204, and positioning the production tool string 214 at a selected depth within the wellbore 204. Coupled to the fluid diverter 222 is a pump 228. The pump 228 is operational to deliver or receive fluid through an internal bore of the production tool string 216 by applying a positive or negative pressure to the internal bore. The pump 228 may also deliver or receive fluid through an annulus 230 formed between a wall of the wellbore 204 and exterior of the production tool string 216 by applying a positive or negative pressure to the annulus 230. The annulus 230 is formed between the production tool string 216 and a wellbore casing 232 when production tool string 216 is disposed within the wellbore 204.

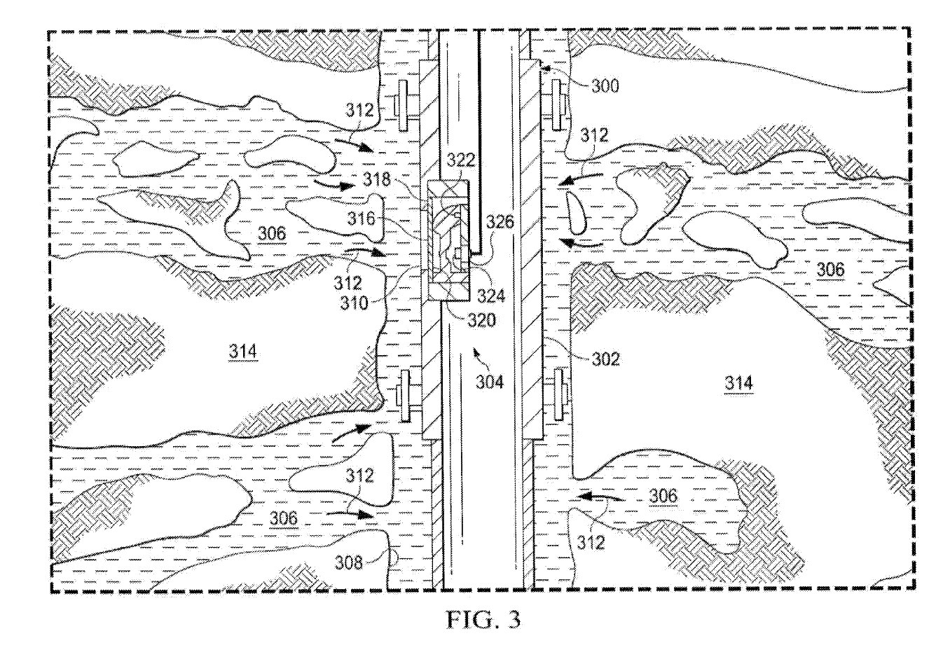

Following formation of the wellbore 204 or as an aspect of forming the wellbore, the production tool string 216 may be equipped with tools and deployed within the wellbore 204 to probe, operate, or maintain the well 214. Specifically, the production tool string 216 may incorporate a tool 234 that characterizes the production fluid 202 produced by the subterranean reservoir 208. A control unit 236 having at least one processor 238 and at least one memory 240 is coupled to a measurement unit (not explicitly shown, but by analogy see 304 in FIG. 3) within the tool 234 and controls data acquisition by the measurement unit. As will be further detailed below, the measurement unit contains at least one integrated computational element to optically analyze sample electromagnetic radiation from the production fluid 202.

In operation, the motorized winch 226, in cooperation with other equipment, extends the production string 216 into the wellbore 204 so that the tool 234 rests proximate the subterranean reservoir 208. The tool 234 characterizes the production fluid 202 at the production fluid's emergence 206 from the subterranean reservoir 208. The pump 228 may be used to manipulate pressure within the internal bore relative to the annulus 230 to regulate flow out of the subterranean reservoir 208. In some embodiments, the control unit 236 may activate the measurement unit within the tool 234 continuously, intermittently, or some combination thereof. Such activation enables the tool 234 to monitor the property of the production fluid 202 as flow exits the subterranean reservoir 208 and enters the wellbore 204.

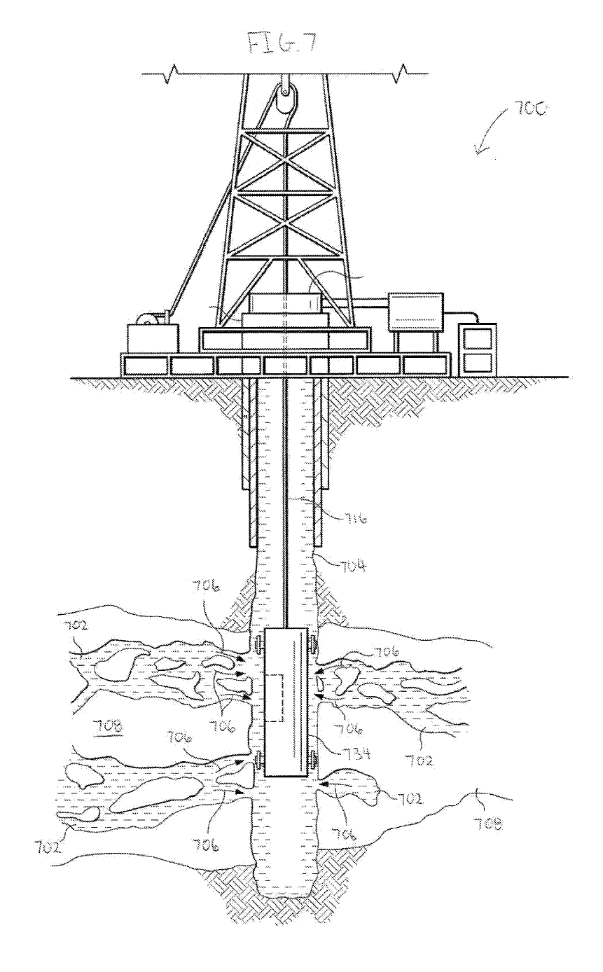

It is noted that while the operating environment shown in FIG. 2 relates to a stationary, land-based rig for raising, lowering, and setting the production tool string 216, in alternative embodiments, mobile rigs, wellbore servicing units (e.g., coiled tubing units, slickline units, or wireline units), and the like may be used to lower the production tool string 216 and/or the tool 234. For example, in FIG. 7, an illustrative embodiment is presented for a measurement system 700 for measuring a property of a production fluid 702 from a wellbore 704 in proximity to an emergence 706 of the production fluid from a subterranean reservoir 708. Further, in this embodiment, a tool 734 that characterizes the production fluid 702 produced by the subterranean reservoir 708, which may be analogous to the tool 234 depicted in FIG. 2, may be deployed into the wellbore 704 using a wireline 716.

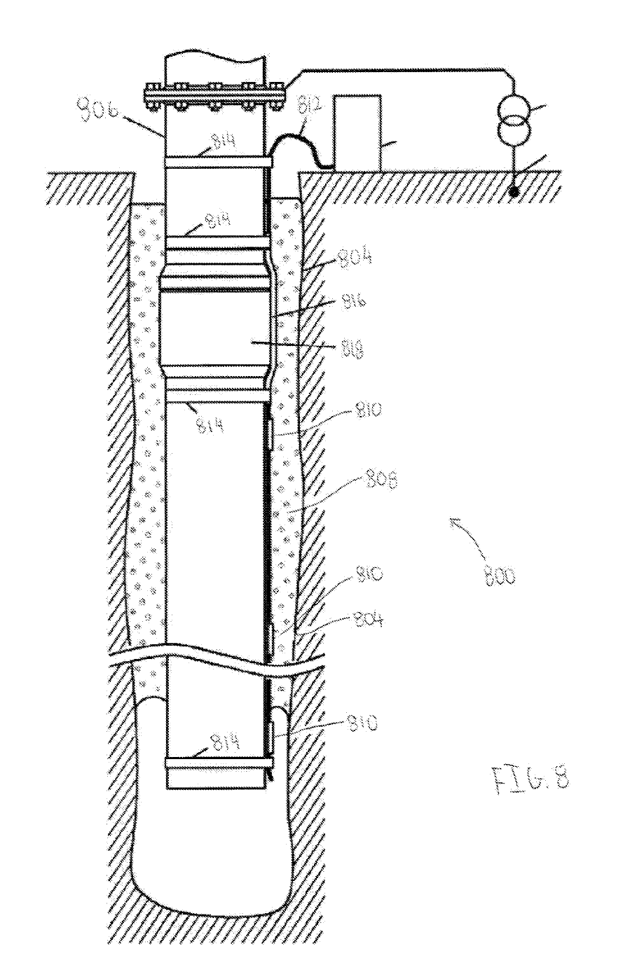

Additionally or alternatively, one or more embodiments of the present disclosure may involve a permanent monitoring application or environment. For example, in FIG. 8, an illustrative embodiment is presented for a measurement system 800 for measuring a property of a production fluid from a wellbore 804. In this embodiment, a casing string 806 may be positioned within the wellbore 804, in which cement 808 may be used to fill in the annular space between the wellbore 804 and the casing string 806 to secure the casing string 806 within the wellbore 804. A tool, similar to the tool 234 depicted in FIG. 2, may be secured within and/or attached to the casing string 806. Additionally or alternatively, one or more measurement units 810, such as similar to the measurement units 304 depicted below with respect to FIG. 3, may be positioned within or about the casing string 806. In this embodiment, multiple measurement units 810 may be secured to the casing string 806, in which one or more cables 812 may be used to send and/or receive signals from the measurements units 810. The cable 812 may be a fiber optic cable in one or more embodiments, the cable 812 may be secured to the casing string 806 using one or more bands 814, and the cable 812 may be protected using a cable protector 816, such as when positioned adjacent to a casing joint 818. Furthermore, while the operating environment is generally discussed as relating to a land-based well, the systems and methods described herein may instead be operated in subsea well configurations accessed by a fixed or floating platform.

In FIG. 3, a portion of the measurement system 200 of FIG. 2 is shown in cross-section and includes an illustrative embodiment of an analytical tool 300. The analytical tool 300 is analogous to the tool 234 depicted in FIG. 2 for characterizing the production fluid 202. The analytical tool 300 may include a housing 302 having a measurement unit 304 disposed therein. The measurement unit 304 may be exposed to a production fluid 306 from a wellbore 308 by one or more fluid inlets 310 to which the measurement unit 304 may be fluidly-coupled. The fluid inlet 310 depicted in FIG. 3 may be proximate an emergence 312 of the production fluid 306 from a subterranean formation 314. The measurement unit 304 may include a window 316 having a first side 318 and a second side 320. The first side 318 may be situated opposite the second side 320 and may face the production fluid 306. In FIG. 3, the first side 318 and the second side 320 may be partitioned by a planar body of the window 316. This illustration is not intended as limiting. The window 316 may contain one or more faceted surfaces, curved surfaces, pocketed surfaces, or grooved surfaces that maintain at least two distinguishable sides. Other optical surfaces are possible.

Proximate the second side 320 of the window 316 may be an illumination source 322. The illumination source 322 may be operable to generate electromagnetic radiation that interacts with the production fluid 306. The illumination source 322 may include a pulsed illumination source. Non-limiting examples of electromagnetic radiation include light having wavelengths in the short-infrared (i.e., 1400-3000 nm), near-infrared (i.e., 750-1400 nm), visible (i.e., 380-750 nm), and ultraviolet (i.e., 100-380 nm) regions. Other wavelengths are possible. In some embodiments, the illumination source 322 may be optically-coupled to a band-pass filter. For example, in one or more embodiments, a band-pass filter may be deposited on the illumination source 322 and/or manufactured or fabricated with the illumination source 322. In such embodiments, the band-pass filter may be configured to transmit a predetermined spectrum of electromagnetic radiation from the illumination source 322.

Also proximate the second side 320 of the window 316 may be an integrated computational element 324. The integrated computational element 324 is analogous to the integrated computational element 100 described in relation to FIG. 1. The integrated computational element 324 may be configured to receive interacted electromagnetic radiation (i.e., sample electromagnetic radiation) for optical processing into a weighted optical spectrum. In some embodiments, the integrated computational element 324 may be optically-coupled to a band-pass filter. For example, in one or more embodiments, a band-pass filter may be deposited on the integrated computational element 324 and/or manufactured or fabricated with the integrated computational element 324. In such embodiments, the band-pass filter may be configured to receive interacted electromagnetic radiation from the production fluid 306 in place of the integrated computational element 324. The band-pass filter may then transmit a predetermined spectrum of the received electromagnetic radiation to the integrated computational element 324. Optically coupled to the integrated computational element 324 may be an optical transducer 326. The optical transducer 326 may be configured to generate electrical signals representing the weighted optical spectrum and can be disposed proximate the second side 320 of the window 316. Non-limiting examples of optical transducers or photodetectors include photodiodes, thermopiles, bolometers, photomultiplier tubes, and pyroelectric detectors. Other optical transducers are possible. In some embodiments, integrated computational element 320 may be optically-coupled to a band-pass filter.

The illumination source 322 may be positioned relative to the integrated computational element 324 so that electromagnetic radiation received by the integrated computational unit 324 may be interacted with the production fluid 306 through reflection. Reflective interaction may be beneficial in cases where the production fluid 306 contains highly-absorbing or solid materials. The illumination source 322 may also positioned relative to the integrated computational element 324 so that electromagnetic radiation received by the integrated computational unit 324 may be interacted with the production fluid 306 via transmission. Transmission may be beneficial in cases where the production fluid 306 includes predominantly liquid or gas phases. In some embodiments, the optical transducer 326 may be electrically coupled to a conversion circuit configured to output electrical signals in the frequency domain. Converting to the frequency domain may allow electrical signals to transmit information over longer distances due to higher signal-to-noise ratios (i.e., relative to absolute voltages or currents).

In operation, the fluid inlet 310 may receive the production fluid 306 proximate the production fluid's emergence 312 from the subterranean reservoir 314. The fluid inlet 310 may convey or allow fluid flow of the production fluid 306 to the first side 318 of the window 316. The illumination source 322 may generate electromagnetic radiation that traverses the window 316 from the second side 320 to the first side 318. The interaction of electromagnetic radiation with the production fluid 306 proximate the first side 318 may produce sample electromagnetic radiation. The sample electromagnetic radiation may be received by the integrated computational element 324 and transformed via optical processing into the weighted optical spectrum. Such optical processing may be governed by a design of the integrated computational element, such as the layers 102, 104 and substrate 106 discussed in relation to FIG. 1. The design may be predetermined to isolate, from sample electromagnetic radiation, the weighted optical spectrum representing the property of the production fluid 306. Through optical coupling, the weighted optical spectrum may be transmitted to the optical transducer 326 which integrates the weighted optical spectrum and generates electrical signals in response. The electrical signals may be conducted downhole and/or at the surface to a control unit and subsequently processed into data for characterizing the production fluid 306. While FIG. 3 illustrates a single measurement unit 304 only, this depiction is not intended as limiting. In some embodiments, two or more measurement units 304 may be disposed into the housing 302 therefore allowing the analytical tool 300 to measure multiple properties of the production fluid 306.

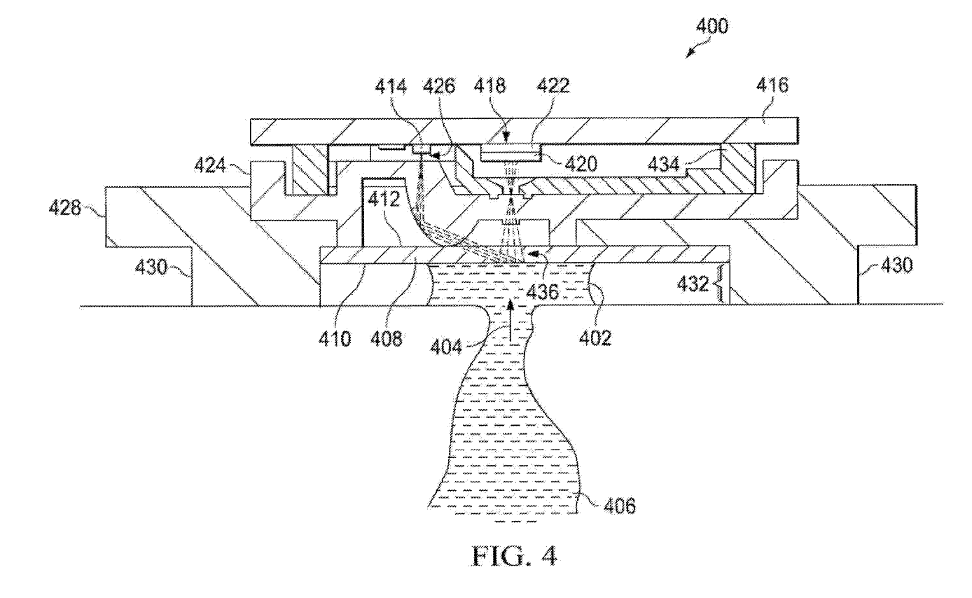

Now referring primarily to FIG. 4, an illustrative embodiment is presented of an apparatus 400 for measuring, using optical reflection, a property of a fluid 402 in proximity to the fluid's emergence 404 from a source 406. The apparatus 400 may be analogous to the measurement unit 304 described in relation to FIG. 3 and may be used therefor. However, while the measurement unit 304 of FIG. 3 is presented in the context of oil and gas production, this context is not intended to limit the apparatus 400 of FIG. 4. The apparatus 400 of FIG. 4 may be used in any application where a fluid, in general, is to be measured in proximity to the fluid's emergence from a source. For example, one or more properties of blood, saliva, perspiration, or other biological fluids can be measured in situ, e.g., upon their extraction or secretion from tissue, by the measurement apparatus 400.

The apparatus 400 may include a window 408 having a first side 410 and a second side 412. The first side 410 may be situated opposite the second side 412 and faces the fluid 402. Although the first side 410 and the second side 412 are partitioned by a planar body in FIG. 4, this illustration is not intended as limiting. The window 408 may contain one or more faceted surfaces, curved surfaces, pocketed surfaces, or grooved surfaces that maintain at least two distinguishable sides. Other optical surfaces are possible. Furthermore, FIG. 4 depicts the fluid 402 as contacting the window 408. It will be appreciated that non-contacting fluids, e.g., a gas near but not touching the window 408, may also be measured by the apparatus 400. The illustration of FIG. 4 should therefore not be considered as limiting.

Proximate the second side 412 of the window 408 and spaced from the window 408 may be an illumination source 414. In some embodiments, the illumination source 414 may be secured to a substrate 416. An optical analyzer 418 may also be situated proximate the second side 412 of the window 408 and includes an integrated computational element 420. The integrated computational element 420 is analogous to the integrated computational element 100 described in relation to FIG. 1. The optical analyzer 418 also may include an optical transducer 422 that is optically coupled to the integrated computational element 420. Non-limiting examples of optical transducers or photodetectors include photodiodes, thermopiles, bolometers, photomultiplier tubes, and pyroelectric detectors. Other photodetectors are possible. In some embodiments, the photodetector 422 is electrically coupled to a conversion circuit configured to output electrical signals in a frequency domain. In other embodiments, the optical analyzer 418 may be secured to the substrate 416.

A first optical guide 424 may be positioned proximate the second side 412 and configured to direct light 426 from the illumination source 414 towards the fluid 402. Non-limiting examples of light 426 include radiation having wavelengths in the short-infrared (i.e., 1400-3000 nm), near-infrared (i.e., 750-1400 nm), visible (i.e., 380-750 nm), and ultraviolet (i.e., 100-380 nm) regions. Other wavelengths are possible. As discussed above, in some embodiments, the illumination source 414 may be optically-coupled to a band-pass filter. For example, in one or more embodiments, a band-pass filter may be deposited on the illumination source 414 and/or manufactured or fabricated with the illumination source 414. In such embodiments, the band-pass filter may be configured to transmit a predetermined spectrum of electromagnetic radiation from the illumination source 414.

The first optical guide 424 may include optical elements such as lenses, mirrors, light pipes, or a combination thereof to direct light 426. To facilitate positioning of the window 408 relative to the first optical guide 424, the measurement apparatus 400 may include a base plate 428. If present, the base plate 428 may couple the window 408 to the first optical guide 424. The base plate 428 may also include one or more protrusions 430 to maintain a predetermined gap 432 between the window 408 and the fluid's emergence 404. The apparatus 400 may also include a second optical guide 434 proximate the second side 412. The second optical guide 428 may be configured to receive interacted light 436 from the fluid 402 and direct the interacted light 436 to the optical analyzer 418. The second optical guide 434 may include optical elements such as lenses, mirrors, light pipes, or a combination thereof to direct interacted light 436.

In FIG. 4, the first optical guide 424 and the second optical guide 434 have been illustrated as distinct optical elements. This illustration, however, is not intended as limiting. In some embodiments, one or both of the guides 424, 434 may include at least two optical elements. In further embodiments, the first optical guide 424 may share one or more optical elements with the second optical guide 434. In other embodiments, the first optical guide 424 and the second optical guide 434 are integrated into a single optical element. Other configurations of the first optical guide 424 and the second optical guide 434 are possible.

In operation, the illumination source 414 may generate light 426 which is directed towards the fluid 402 by the first optical guide 424. In some embodiments, the directive capability of the first optical guide 424 may include refraction by one or more lenses. In other embodiments, the directive capability of the first optical guide 424 may include reflection from one or more mirrored surfaces. In still other embodiments, the directive capability of the first optical guide 424 may include total internal reflection within one or more light pipes. The light 426 may traverse the window 408 from the second side 412 to the first side 410 to interact with the fluid 402. Reflection from the fluid 402 may produce interacted light 436 which traverses back through the window 408 towards the second side 412. The first optical guide 424 may direct interacted light to the second optical guide 434, which receives such interacted light 436 and directs the interacted light 436 to the optical analyzer 418. In some embodiments, the directive capability of the first optical guide 424 may include refraction by one or more lenses. In other embodiments, the directive capability of the first optical guide 424 may include reflection from one or more mirrored surfaces. In still other embodiments, the directive capability of the first optical guide 424 may include total internal reflection within one or more light pipes.

The integrated computational element 420 of the optical analyzer 418 may optically process the interacted light 436 into the weighted optical spectrum. Such optical processing may be governed by a design of the integrated computational element, such as the layers 102, 104 and substrate 106 discussed in relation to FIG. 1. The design may be predetermined to isolate, from interacted light 436, the weighted optical spectrum representing the property of the fluid 402. As discussed above, in some embodiments, the integrated computational element 420 may be optically-coupled to a band-pass filter. For example, in one or more embodiments, a band-pass filter may be deposited on the integrated computational element 420 and/or manufactured or fabricated with the integrated computational element 420. In such embodiments, the band-pass filter may be configured to receive interacted light 436 from the production fluid 402 in place of the integrated computational element 420. The band-pass filter may then transmit a predetermined spectrum of the received electromagnetic radiation to the integrated computational element 420. Through optical coupling, the weighted optical spectrum may be transmitted to the photodetector 422 which, in response, integrates the weighted optical spectrum and generates electrical signals. If the conversion circuit is present, electrical signals from the apparatus 400 may be produced in the frequency domain. Other signals may be used.

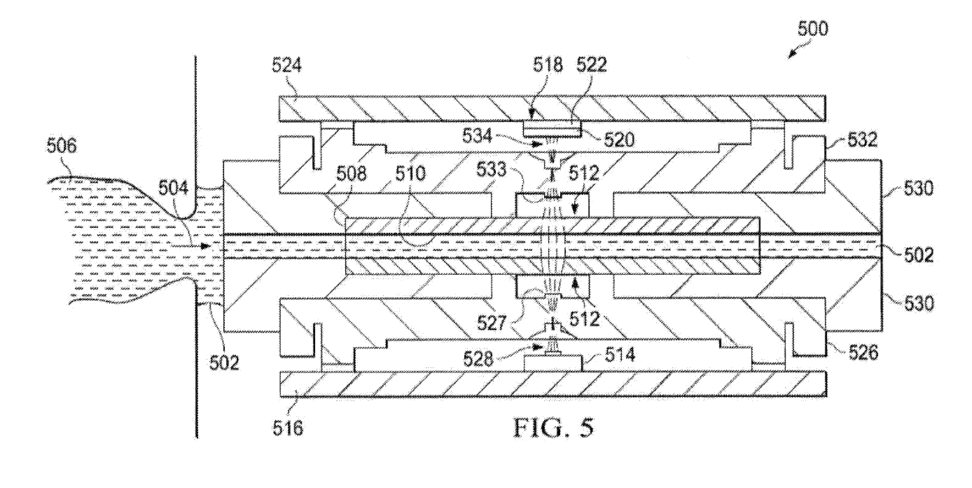

The interacted light 436 in FIG. 4 is illustrated as being produced through reflection from the fluid 402. This illustration, however, is not intended as limiting of the present disclosure. The first optical guide 424 and second optical guide 434 can be positioned relative to each other such that interacted light 436 received by the second optical guide 434 and first optical guide 424 is produced via transmission through the fluid 402 such as shown in FIG. 5.

FIG. 5 presents an apparatus 500 for measuring, using optical transmission, a characteristic of a fluid 502 in proximity to the fluid's emergence 504 from a source 506. The apparatus 500 may be used as the measurement unit 304 in FIG. 3. The apparatus 500 may measure the characteristic by transmitting light through the fluid 502. Similar to FIG. 4, the apparatus 500 of FIG. 5 may be analogous to the measurement unit 304 described in relation to FIG. 3. However, the apparatus 500 may also be used in any application where a fluid, in general, is to be measured in proximity to the fluid's emergence from a source.

The apparatus 500 may include a window 508 having a first side 510 and a second side 512. The first side 510 may be situated opposite the second side 512 and faces the fluid 502. It should be noted that, in FIG. 5, the first side 510 may be an interior of the window 508 and the second side 512 may be an exterior. Such topology is possible, for example, with a tube. Alternate topologies, however, are possible for the window 508 to enable a transmissive interaction of light with the fluid 502. Although the first side 510 and the second side 512 may be partitioned by a hollow cylindrical body in FIG. 5, this illustration is not intended as limiting. The window 508 may contain one or more faceted surfaces, dimpled surfaces, pocketed surfaces, or grooved surfaces that maintain at least two distinguishable sides for transmission. The hollow body of the window 508 may also include non-cylindrical cross-sections (e.g., eccentric, ovate, etc.). Other optical surfaces or cross-sections are possible.

On the same side as the second side 512 of the window 508 is an illumination source 514. In some embodiments, the illumination source 514 is secured to a substrate 516. An optical analyzer 518 may also be situated on the same side as the second side 512 of the window 508 and includes an integrated computational element 520. The integrated computational element 520 is analogous to the integrated computational element 100 described in relation to FIG. 1. The optical analyzer 518 may also include a photodetector 522 that may be optically coupled to the integrated computational element 520. Non-limiting examples of photodetectors include photodiodes, thermopiles, bolometers, photomultiplier tubes, and pyroelectric detectors. Other photodetectors are possible. In some embodiments, the photodetector 522 may be electrically coupled to a conversion circuit configured to output electrical signals in a frequency domain or other type of signal, e.g., an amplified voltage. In some embodiments, the optical analyzer 518 is secured to a substrate 524. In further embodiments, the substrate 524 for the optical analyzer 518 may be the same as the substrate 516 for the illumination source 514. In such embodiments, the substrate may be a circular member.

A first optical guide 526 may be positioned proximate the second side 512 and configured to direct light 528 from the illumination source 514 towards the fluid 502. Non-limiting examples of light 528 may include radiation having wavelengths in the short-infrared (i.e., 1400-3000 nm), near-infrared (i.e., 750-1400 nm), visible (i.e., 380-750 nm), and ultraviolet (i.e., 100-380 nm) regions. The first optical guide 526 may include optical elements such as lenses, mirrors, light pipes, or a combination thereof to direct light 528. In the illustrative embodiment of FIG. 5, the first optical guide 526 includes a first lens 527. To facilitate positioning of the first optical guide 526 relative to the window 508, the measurement apparatus 500 may include a spacer 530. If present, the spacer 530 may couple the first optical guide 526 to the window 508.

The apparatus 500 may also include a second optical guide 532 on the same side as the second side 512. The second optical guide 532 may be configured to receive interacted light 534 from the fluid 502 and direct the interacted light 534 to the optical analyzer 518. The second optical guide 532 may include optical elements such as lenses, mirrors, light pipes, or a combination thereof to direct interacted light 534. In the illustrated embodiment of FIG. 5, the second optical guide 532 may include a second lens 533. If present, the spacer 530 may also couple the second optical guide 532 to the window 508.

In FIG. 5, the first optical guide 526 and the second optical guide 532 have been illustrated as distinct optical elements. This illustration, however, is not intended as limiting. In some embodiments, one or both of the guides include at least two optical elements. In further embodiments, the first optical guide 526 may share one or more optical elements with the second optical guide 532. In other embodiments, the first optical guide 526 and the second optical guide 532 are integrated into a single optical element. Other configurations of the first optical guide 526 and the second optical guide 532 are possible. In addition, while two optical guides are described, more than two can be used, either separately or in conjunction with other optical guides. For example, one or more optical guides can be disposed on either side of the window 508.

In operation, according to an illustrative embodiment, the illumination source 514 may generate light 528 that is directed towards the fluid 502 by the first optical guide 526. In some embodiments, the directive capability of the first optical guide 526 may include refraction by one or more lenses 527. In other embodiments, the directive capability of the first optical guide 526 may include reflection from one or more mirrored surfaces (not shown). In other embodiments, the directive capability of the first optical guide 526 may include total internal reflection within one or more light pipes. The light 528 may traverse the window 508 from the second side 512 to the first side 510 to interact with the fluid 502. Transmission through the fluid 502 may produce interacted light 534 which traverses back through the window 508 towards the second side 512.

The second optical guide 532 may receive such interacted light 534 and may direct the interacted light 534 to the optical analyzer 518. In some embodiments, the directive capability of the second optical guide 532 may include refraction by one or more lenses 533. In other embodiments, the directive capability of the second optical guide 532 may include reflection from one or more mirrored surfaces (not shown). In other embodiments, the directive capability of the second optical guide 532 may include total internal reflection within one or more light pipes. The integrated computational element 520 of the optical analyzer 518 may optically process the interacted light 534 into the weighted optical spectrum. Such optical processing may be governed by a design of the integrated computational element 520, such as the layers 102, 104 and substrate 106 discussed in relation to FIG. 1. The design may be predetermined to isolate, from interacted light 534, the weighted optical spectrum representing the property of the fluid 502. Through optical coupling, the weighted optical spectrum may be transmitted to the photodetector 522 which, in response, may generate electrical signals. If the conversion circuit is present, electrical signals from the apparatus 500 may be produced in the frequency domain or other signal type.

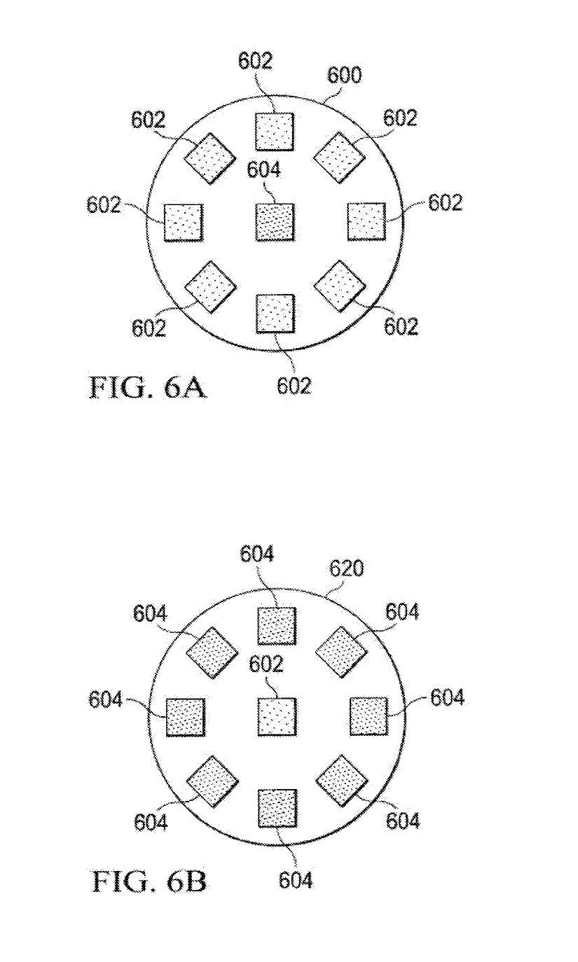

Now referring primarily to FIGS. 6A and 6B, alternative embodiments of illumination sources or optical analyzers on substrates 600, 620 are presented. The substrates 600, 620 are analogous to the substrate 416 described in regards to FIG. 4 but differ in certain aspects relating to the number and configuration of illumination sources and optical analyzers secured on each substrate 600, 620. The plurality of illumination sources may be selectively directed to an optical analyzer as described herein. Similarly, the plurality of optical analyzers may be used to receive interacted light and process the light according different designs herein.

Referring more particularly to FIG. 6A, a substrate 600 having a plurality of illumination sources 602 and an optical analyzer 604 is presented. While FIG. 6A depicts eight illumination sources 602 forming a circular perimeter around a central optical analyzer 604, this depiction is not intended as limiting. Any number, configuration, and arrangement of illumination sources 602 may be used in keeping with the principles of this disclosure. The shape of the substrate 600 need not be circular. A plurality of illumination sources 602 may be beneficial in applications where a single illumination source cannot provide sufficient intensity in a desired wavelength range. When incorporated into an apparatus, such as the apparatus 400 of FIG. 4, it will be appreciated that the first optical guide will be configured to direct light from each illumination source 602 towards the fluid under measurement. The illumination sources 602 may be activated individually, in patterns, or all together.

Referring now to FIG. 6B, a substrate 620 having a plurality of optical analyzers 604 and an illumination source 602 is presented. While FIG. 6A illustrates eight optical analyzers 604 forming a circular perimeter around an illumination source 602, this illustration is not intended as limiting. Any number, configuration, and arrangement of optical analyzers 604 may be used in keeping with the principles of this disclosure. The shape of the substrate 620 need not be circular. A plurality of optical analyzers 604 may be beneficial in applications where a measurement of multiple fluid properties is desired, as a single optical analyzer is typically restricted to a single property. A plurality of optical analyzers 604 may also be beneficial if the determination of fluid velocity is desired. In this application, the drift of bubbles, for example, can be measured across pairs of optical analyzers 604, each pair corresponding to an axis of motion. When incorporated into an apparatus, such as the apparatus 400 of FIG. 4, it will be appreciated that the second optical guide is configured to direct interacted light from the fluid to each optical analyzer 604.

Although the present disclosure and its advantages have been described in the context of certain illustrative, non-limiting embodiments, it should be understood that various changes, substitutions, permutations, and alterations can be made without departing from the scope of the disclosure as defined by the appended claims. It will be appreciated that any feature that is described in connection to any one embodiment may also be applicable to any other embodiment.

It will be understood that the benefits and advantages described above may relate to one embodiment or may relate to several embodiments. It will further be understood that reference to “an” item refers to one or more of those items.

The steps of the methods described herein may be carried out in any suitable order or simultaneous where appropriate. Where appropriate, aspects of any of the examples described above may be combined with aspects of any of the other examples described to form further examples having comparable or different properties and addressing the same or different problems.

It will be understood that the above description of the embodiments is given by way of example only and that various modifications may be made by those skilled in the art. The above specification, examples, and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the scope of the claims.

In addition to the embodiments described above, many examples of specific combinations are within the scope of the disclosure, some which are detailed below.

### Example 1

A system for measuring a property of a sample, the system comprising:
a housing having a sample inlet;
a measurement unit coupled to the housing and coupled to the at least one sample inlet, the measurement unit comprising:
   a window having a first side and a second side, the first side opposite the second side and facing the sample;
   an illumination source disposed proximate the second side of the window to generate electromagnetic radiation;
   an integrated computational element disposed proximate the second side of the window to receive electromagnetic radiation that has interacted with the sample;
   an optical transducer disposed proximate the second side of the window and optically coupled to the integrated computational element;
   wherein the illumination source is positioned relative to the integrated computational element such that electromagnetic radiation received by the integrated computational unit is first interacted with the sample through reflection or transmission,
   wherein the integrated computational element processes interacted electromagnetic radiation from the sample to produce a weighted optical spectrum and transfers the weighted optical spectrum to the optical transducer, and
   wherein the optical transducer generates electrical signals representing the weighted optical spectrum; and
a control unit coupled to the measurement unit, the control unit having at least one processor and at least one memory to control data acquisition by the measurement unit.

### Example 2

The system of Example 1, wherein the measurement unit further comprises a conversion circuit coupled to the optical transducer to output electrical signals from the optical transducer in the frequency domain.

### Example 3

The system of Example 1 or 2, wherein the optical transducer comprises a thermopile detector.

### Example 4

The system of Example 1 or 2, wherein an band-pass filter is optically coupled to the illumination source or the optical transducer, wherein the band-pass filter transmits a predetermined spectrum of electromagnetic radiation and eliminates a selected spectral range of electromagnetic radiation.

### Example 5

The system of Example 4, wherein the illumination source comprises the band-pass filter deposited on the illumination source.

### Example 6

The system of Example 1 or 2, wherein the integrated computational element is optically coupled to a band-pass filter, wherein the band-pass filter receives interacted radiation from the sample in place of the integrated computational unit, and wherein the band pass filter transmits a predetermined spectrum of interacted electromagnetic radiation to the integrated computational unit.

### Example 7

The system of Example 6, wherein the integrated computational element comprises the band-pass filter such that the band-pass filter is deposited on the integrated computational element.

### Example 8

The system of Example 1 or 2, wherein the illumination source is a pulsed illumination source.

### Example 9

An apparatus for measuring a characteristic of a sample, the apparatus comprising:
a window having a first side and a second side, the first side opposite the second side and facing the sample;
one or more illumination sources disposed proximate the second side of the window;
one or more optical analyzers disposed proximate the second side of the window, the optical analyzer comprising an integrated computational element optically coupled to an optical transducer;
an optical guide disposed proximate the second side of the window to direct electromagnetic radiation from the illumination source towards the sample for interaction of the directed electromagnetic radiation with the sample and to receive interacted electromagnetic radiation from the sample and direct the received interacted electromagnetic radiation to the optical analyzer, and
wherein the integrated computational element is configured to process the interacted electromagnetic radiation from the sample into a weighted optical spectrum and transfer the weighted optical spectrum to the optical transducer, and
wherein the optical transducer generates electrical signals representing the weighted optical spectrum.

### Example 10

The apparatus of Example 9, wherein the optical guide comprises a first optical guide and a second optical guide, wherein the first optical guide directs electromagnetic radiation from the illumination source towards the sample for interaction of the directed electromagnetic radiation with the sample, and wherein the second optical guide receives interacted electromagnetic radiation from the sample and directs the received interacted electromagnetic radiation to the optical analyzer.

### Example 11

The apparatus of Example 10, wherein the second optical guide is positioned relative to the first optical guide such that interacted electromagnetic radiation received by the second optical guide is produced via reflection from the sample.

### Example 12

The apparatus of Example 10, wherein the second optical guide is positioned relative to the first optical guide such that interacted electromagnetic radiation received by the second optical guide is produced via transmission through the sample.

### Example 13

The apparatus of any one of Examples 9-12, wherein the one or more illumination source comprises a plurality of illumination sources and the optical guide directs electromagnetic radiation from the plurality of illumination sources towards the sample.

### Example 14

The apparatus of Example 13, wherein the plurality of illumination sources and the one or more optical analyzers are secured on a substrate, and wherein the substrate positions the plurality of illumination sources along a perimeter around the one or more optical analyzers.

### Example 15

The apparatus of any one of Examples 9-12, wherein the one or more optical analyzers comprises a plurality of optical analyzers and wherein the second optical guide directs interacted light from the sample to the plurality of optical analyzers.

### Example 16

The apparatus of Example 15, wherein the one or more optical analyzers and the one or more illumination sources are secured on a substrate, and wherein the substrate positions the plurality of optical analyzers along a perimeter around the one or more illumination sources.

### Example 17

The apparatus of any one of Examples 9-12, wherein the apparatus further comprises a band-pass filter optically coupled to the at least one illumination source and the at least one optical transducer in the at least one optical analyzer, and wherein the band-pass filter transmits a predetermined spectrum of light from the illumination source and eliminates unwanted electromagnetic radiation.

### Example 18

The apparatus of Example 9, wherein the optical guide comprises at least one of a lens to refract the electromagnetic radiation, a mirrored surface to reflect the electromagnetic radiation, and a light pipe to internally reflect the electromagnetic radiation.

### Example 19

A method to measure a characteristic of a sample, the method comprising:
emitting electromagnetic radiation from an illumination source;
directing the electromagnetic radiation with an optical guide into a window, thereby enabling the electromagnetic radiation to interact with the sample and produce interacted electromagnetic radiation;
directing the interacted electromagnetic radiation with the optical guide to an integrated computational element;
processing the interacted electromagnetic radiation into a weighted optical spectrum with the integrated computational element;
transferring the weighted optical spectrum to an optical transducer; and generating an electrical signal with the optical transducer representing the weighted optical spectrum.

### Example 20

The method of Example 19, wherein the optical guide comprises a first optical guide and a second optical guide, wherein the directing the electromagnetic radiation comprises directing the electromagnetic radiation with the first optical guide into the window, and wherein the directing the interacted electromagnetic radiation comprises directing the interacted electromagnetic radiation with the second optical guide to the integrated computational element.

1. A system for measuring a property of a sample, the system comprising:
a housing having a sample inlet to receive the sample;
a measurement unit coupled to the housing and coupled to the sample inlet, the measurement unit comprising:
a window having a first side and a second side, the first side opposite the second side and facing the sample;
an illumination source disposed proximate the second side of the window to generate electromagnetic radiation;
an optical guide disposed proximate the second side of the window to direct the electromagnetic radiation from the illumination source towards the sample, wherein the sample interacts with the electromagnetic radiation;
an integrated computational element (ICE) disposed proximate the second side of the window to receive the interacted electromagnetic radiation, wherein the optical guide directs the interacted electromagnetic radiation to the ICE; and
an optical transducer disposed proximate the second side of the window and optically coupled to the ICE;
wherein the illumination source is positioned relative to the ICE such that the interacted electromagnetic radiation received by the ICE is first interacted with the sample through reflection or transmission,
wherein the ICE processes the interacted electromagnetic radiation from the the optical guide to produce a weighted optical spectrum and transfers the weighted optical spectrum to the optical transducer, and
wherein the optical transducer generates electrical signals representing the weighted optical spectrum; and
a control unit coupled to the measurement unit, the control unit having at least one processor and at least one memory to control data acquisition by the measurement unit.

2. The system of claim 1, wherein the measurement unit further comprises a conversion circuit coupled to the optical transducer to output electrical signals from the optical transducer in the frequency domain.

3. The system of claim 1, wherein the optical transducer comprises a thermopile detector.

4. The system of claim 1, wherein an band-pass filter is optically coupled to the illumination source or the optical transducer, wherein the band-pass filter transmits a predetermined spectrum of electromagnetic radiation and eliminates a selected spectral range of electromagnetic radiation.

5. The system of claim 4, wherein the illumination source comprises the band-pass filter deposited on the illumination source.

6. The system of claim 1, wherein the ICE is optically coupled to a band-pass filter, wherein the band-pass filter receives the interacted electromagnetic radiation from the sample in place of the (ICE), and wherein the band pass filter transmits a predetermined spectrum of the interacted electromagnetic radiation to the integrated computational unit.

7. The system of claim 6, wherein the ICE comprises the band-pass filter such that the band-pass filter is deposited on the ICE.

8. The system of claim 1, wherein the illumination source is a pulsed illumination source.

9. An apparatus for measuring a characteristic of a sample, the apparatus comprising:
a window having a first side and a second side, the first side opposite the second side and facing the sample;
one or more illumination sources disposed proximate the second side of the window;
one or more optical analyzers disposed proximate the second side of the window, the optical analyzer comprising an integrated computational element (ICE) optically coupled to an optical transducer;
an optical guide disposed proximate the second side of the window to direct electromagnetic radiation from the illumination source towards the sample for interaction of the directed electromagnetic radiation with the sample and to receive the interacted electromagnetic radiation from the sample and to direct the received interacted electromagnetic radiation to the optical analyzer, and
wherein the ICE is configured to process the interacted electromagnetic radiation from the optical guide into a weighted optical spectrum and transfer the weighted optical spectrum to the optical transducer, and
wherein the optical transducer generates electrical signals representing the weighted optical spectrum.

10. The apparatus of claim 9, wherein the optical guide comprises a first optical guide and a second optical guide, wherein the first optical guide directs the electromagnetic radiation from the illumination source towards the sample for interaction of the directed electromagnetic radiation with the sample, and wherein the second optical guide receives the interacted electromagnetic radiation from the sample and directs the received interacted electromagnetic radiation to the optical analyzer.

11. The apparatus of claim 10, wherein the second optical guide is positioned relative to the first optical guide such that interacted electromagnetic radiation received by the second optical guide is produced via reflection from the sample.

12. The apparatus of claim 10, wherein the second optical guide is positioned relative to the first optical guide such that interacted electromagnetic radiation received by the second optical guide is produced via transmission through the sample.

13. The apparatus of any one of claim 9, wherein the one or more illumination source comprises a plurality of illumination sources and the optical guide directs electromagnetic radiation from the plurality of illumination sources towards the sample.

14. The apparatus of claim 13, wherein the plurality of illumination sources and the one or more optical analyzers are secured on a substrate, and wherein the substrate positions the plurality of illumination sources along a perimeter around the one or more optical analyzers.

15. The apparatus of any one of claim 9, wherein the one or more optical analyzers comprises a plurality of optical analyzers and wherein the second optical guide directs interacted light from the sample to the plurality of optical analyzers.

16. The apparatus of claim 15, wherein the one or more optical analyzers and the one or more illumination sources are secured on a substrate, and wherein the substrate positions the plurality of optical analyzers along a perimeter around the one or more illumination sources.

17. The apparatus of any one of claim 9, wherein the apparatus further comprises a band-pass filter optically coupled to at least one illumination source and at least one optical transducer in at least one optical analyzer, and wherein the band-pass filter transmits a predetermined spectrum of light from the at least one illumination source and eliminates unwanted electromagnetic radiation.

18. The apparatus of claim 9, wherein the optical guide comprises at least one of a lens to refract the electromagnetic radiation, a mirrored surface to reflect the electromagnetic radiation, and a light pipe to internally reflect the electromagnetic radiation.

19. A method to measure a characteristic of a sample, the method comprising:
emitting electromagnetic radiation from an illumination source;
directing the electromagnetic radiation with an optical guide into a window, thereby enabling the electromagnetic radiation to interact with the sample and produce interacted electromagnetic radiation;
directing the interacted electromagnetic radiation with the optical guide to an integrated computational element (ICE);
processing the interacted electromagnetic radiation into a weighted optical spectrum with the ICE;
transferring the weighted optical spectrum to an optical transducer; and
generating an electrical signal with the optical transducer representing the weighted optical spectrum.

20. The method of claim 19, wherein the optical guide comprises a first optical guide and a second optical guide, wherein the directing the electromagnetic radiation comprises directing the electromagnetic radiation with the first optical guide into the window, and wherein the directing the interacted electromagnetic radiation comprises directing the interacted electromagnetic radiation with the second optical guide to the ICE.
